(19) United States
(12) Patent Application Publication
(10) Pub. No.: US 2002/0128742 A1
(43) Pub. Date: Sep. 12, 2002

(54) Accurate portraits

(76) Inventor: Robert M. Zieverink, Wake Forest, NC (US)

Correspondence Address: Jeffrey K. Seto, 617 Tinkerbell rd, Chape Hill, NC, 27514, US

(21) Appl. No.: 09/803,517

(22) Filed: Mar. 12, 2001

(51) Int. Cl. G06F 19/00

(52) U.S. Cl. 700/159

(57) ABSTRACT

A method and machine for making personalized jewelry. An item, animal, human body or face, or multiples thereof is scanned using white light phase scanning, laser based scanning, or two-dimensional video silhouette imaging or other full three-dimensional scanning technology. Preferably the object has some sentimental value. A digital file of the object is created and stored in a memory. This digital file is then manipulated for an appropriate jewelry design. A new numerical file, comprising milling machine instructions, is then created. The milling machine executes these instructions and with further traditional jewelry finishing techniques a finished jewelry product is produced. A piece of precious metal, for example, with the replicated image can be worn as a pendant, charm, earrings, broach, or other type of jewelry. The method can be used to turn exact three-dimensional facial or full head portraits into pieces of jewelry.

### BACKGROUND OF THE INVENTION

The present invention relates generally to the field of jewelry manufacturing and more specifically to a machine and method for scanning a three or four-dimensional object and milling at least a portion of the captured image in a base material, such gold or silver, to produce a piece of jewelry.

During the early part of the 20^{th} century, machine tools were enlarged and accuracy improved. After 1920 they became more specialized in their applications. From about 1930 to 1950 more powerful and rigid machine tools were built to effectively utilize the improved cutting materials that had become available. These specialized machine tools made it possible to manufacture standardized products economically. The machines, however, lacked flexibility and they were not adaptable to a variety of products or to variations in manufacturing standards. As a result, in the past decades engineers have developed highly versatile and accurate machine tools that have been adapted to computer control, making possible the manufacture of products with complex designs.

Jewelry holds an important place in history and continues to play an integral role in society today. The giving and receiving of precious metals, rare stones, and other forms of jewelry has been the universal sign of love, gratuity and loyalty. Such gifts allow the poorest of recipients to at least temporarily feel like royalty. Rare stones such as rubies and emeralds can be cut and polished to accent the light that shines through the stones and may subsequently be mounted on a ring or worn as a pendant. Precious metals, such as gold and silver, can also be worn as rings and pendants but also have the additional characteristic of being engraveable and millable. These characteristics allow these metals to take on many different forms, thus giving jewelry making many more possibilities. Precious metals can be engraved with name, initials or a short message, to personalize the gift. Personalizing gifts and otherwise making gifts unique gives an additional quality to the gift.

A novel way of personalizing a piece of jewelry for a parent is to decorate the piece of jewelry with their child's facial or full body image. In such a technique, one of several scanning technologies is used to capture a numerical three dimensional profile of the child's face, body or another object. The object's image is captured through any method capable of digital capturing, such as laser based scanning, two dimensional video silhouette images or white light phase measurement, for example. The digital image is stored via a numerical coding system. The object(s) in the image can be virtually anything, such as a face, a body, or an inanimate object. The generated numerical code is used to instruct a milling machine in the milling of the three or four-dimensional object into a three or four-dimensional piece of jewelry. Such techniques of capturing three-dimensional profiles are used in the fields of motion picture special effects and the custom fitting clothing industry. The clothing industry, for example, uses laser based scanning to measure customers and make exact custom fit clothes for the customer, from head to foot. In the present method of image capturing a person or object is placed in a scanning booth and a three or four-dimensional numerical profile is generated. This numerical profile can contain hundreds of thousands, or more, data points, which are stored on data discs. This digital data can be processed by processing circuitry and manipulated by computer software and even provided with pre-existing three dimensional background profiles, to create a composite three-dimensional picture in numerical values. The present method involves loading a three-dimensional computer “portrait file” of a face, flowers or birds, for instance, into a three or four axis milling machine. The portrait file instructs the machine so that a piece of metal, wood or other material is milled so that a replica of the captured image is created in the material.

The scanning apparatus is used to scan and capture a three-dimensional numerical profile of a subject. This numerical file is manipulated by a computer as to distortion, size, background, etc. A new numerical code is produced to accurately replicate the original object. This file is then received and processed by the milling machine and causes the milling machine to cut with metal cutting bits into a piece of material held by the milling machine, typically in a vice. The milling takes place and a rough piece of jewelry is produced. After some finishing, the milled material is made into a finished piece of jewelry, such as a “portrait” charm, pendant, broach or ring, for example. Upon completion by the present method, the resulting piece of jewelry provides a permanent reminder of a child, parent, family, animal, or scene that is sentimental to them.

There are several ways to obtain full three-dimensional profiles of faces, animals, full bodies, flowers, or other tangible items. In the preferred embodiment, white light based scanners included in a scanning booth are used. These scanners capture hundreds of thousands of data points of the image scanned. Processing circuitry then compiles, compares, and manipulates the data to produce an extremely accurate three-dimensional profile of the scanned product. This process is known as white light phase measurement profilometry (PMP). The PMP full body scan system is now commercially available. Another way of capturing a profile in three-dimension is laser based scanning whereby a laser is used to again acquire a full three-dimensional image of the scanned object. A third way of capturing an object's image is two-dimensional video silhouette imaging.

These digital capturing methods produce numerical locations for hundreds of thousands of measurement points, which may correlate to a full three-dimensional human head, for example. This “head data” is processed by computer software to produce a numerical code so the milling machine can now mill out of a given material, such as metal, wood, or plastic, the full front, sides and back of the head.

Regarding the milling process, there are many different methods for removing selected areas from a piece of metal. In a milling machine, a workpiece is fed against a circular device with a series of cutting edges on its circumference. The workpiece is held on a table that controls the feed against the cutter. The table conventionally has three or four possible movements: longitudinal, horizontal, vertical; in some cases it can also rotate. Milling machines are the most versatile of all machine tools. Flat or contoured surfaces may be machined with excellent finish and accuracy. Angles, slots, gear teeth, and recess cuts can be made by using various cutters within the milling machine.

Grinding is the removal of metal by a rotating abrasive wheel; the action is similar to that of a milling cutter. The wheel is composed of many small grains of abrasive, bonded together, with each grain acting as a miniature cutting tool. The process produces extremely smooth and accurate finishes. Because only a small amount of material is removed at each pass of the wheel, grinding machines require fine wheel regulations. The pressure of the wheel against the workpiece can be made very slight, so that grinding can be carried out on fragile materials that cannot be machined by other conventional devices.

Unconventional machines include plasma-arc, laser-beam, electrodischarge, electrochemical, ultrasonic, and electron-beam machines. These machine tools were developed primarily to shape the ultrahard alloys used in heavy industry and in aerospace applications and to shape and etch the ultrathin materials used in such electronic devices as microprocessors.

Plasma-arc machining (PAM) employs a high-velocity jet of high-temperature gas to melt and displace materials in its path. The materials cut by PAM are generally those that are difficult to cut by any other means, such as stainless steels and aluminum alloys.

Laser-beam machining (LBM) is accomplished by manipulating a beam of coherent light (or laser) to vaporize unwanted materials. LBM is particularly suited to making accurately placed holes. The LBM process can make holes in refractory metals and ceramics and in very thin materials without warping the workpiece. Extremely fine wires can also be welded using LBM equipment.

Electrodischarge machining (EDM), also known as spark erosion, employs electrical energy to remove metal from the workpiece without touching it. A pulsating high-frequency electric current is applied between the tool point and the workpiece, causing sparks to jump the gap and vaporize small areas of the workpiece. EDM can produce shapes unobtainable by any conventional machining process.

Electrochemical machining (ECM) also uses electrical energy to remove material. An electrolytic cell is created in an electrolyte medium, with the tool as the cathode and the workpiece as the anode. A high-amperage, low-voltage current is used to dissolve the material and remove it from the workpiece, which must be electrically conductive. ECM can perform a wide variety of operations; these operations include etching, marking, hole making, and milling.

Ultrasonic machining (USM) employs high-frequency, low-amplitude vibrations to create holes and other cavities. A relatively soft tool is shaped as desired and vibrated against the workpiece while a mixture of abrasive and water flows between them. The friction of the abrasive particles gradually cuts the workpiece. Materials such as hardened steel, carbides, rubies, quartz, diamonds, and glass can easily be machined by USM.

### SUMMARY OF THE INVENTION

A method and machine that replicates a full dimensional face, body, portrait, animal, or similar object, whereby an electronically captured “profile” of that object is given numerical values. The method involves capturing the full three-dimensional or four-dimensional object, storing a digital representation of that object, manipulating the object with computer software and producing a numerical code, comprising machine instructions, so that a milling machine can replicate the captured object in accurate detail. The object can be any “scanned” full body object that can be captured by means of commercial three-dimensional or four-dimensional full body capturing devices. This object can be captured by novice or professional and preferably has some sentimental value to the wearer of the jewelry. The system may comprise separate modules that are electrically connected or one integrated unit. The system also allows for colorization of the piece of jewelry by adding, for example, colored resins with hardeners as well as enamels or other coloring agents.

### BRIEF DESCRIPTION OF THE DRAWINGS

The invention of the present application will now be described in more detail with reference to the accompanying drawings, given only by way of example, in which:

FIG. 1 is a schematic diagram of the present system;

FIG. 2 is a flow chart of major steps in the present method;

FIG. 3 is an example of a human subject standing in a scanning booth to capture his multi-dimensional image;

FIG. 4 is a frontal view of a captured image and two exemplary pieces of jewelry;

FIG. 5 is an exemplary charm bracelet that can be personalized using the present method.

### DETAILED DESCRIPTION OF THE INVENTION

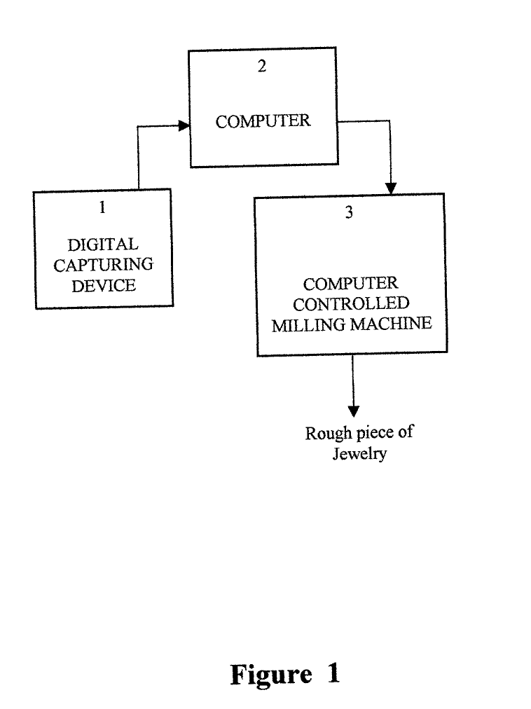

Referring to FIG. 1 the main components of the present jewelry making system are schematically shown. Digital Capturing Device 1 is used to capture a three dimensional or four dimensional image of an object, that may be a person. In the preferred embodiment capturing device 1 is a white light based scanner that capture hundreds of thousands of data points of the scanned object. The white light based scanner then compiles, compares, and manipulates the image data to produce an extremely accurate three-dimensional digital profile of the scanned object. This scanning system, also known as white light phase measurement profilometry (PMP), produces full body scan files and as discussed above, is now commercially available. In an alternative method the device for capturing a three dimensional digital profile is a laser based scanning system, wherein one or more lasers are used to acquire a full three-dimensional image of a scanned object. In a third embodiment, the digital capturing device 1 is a two-dimensional video silhouette imaging system.

No matter what embodiment is used, digital capturing device 1 produces a multi-dimensional digital profile of the scanned object, or person, that can be stored and electronically transferred. Computer 2 receives the multi-dimensional digital profile from capturing device 1 and processes the date to produce a numerical profile of the scanned object or person. This numerical profile of the object or person is then stored in the computer's memory, in one or more memory chips or storage disks. Of course since the profile is in a digital format, the profile can be electronically transmitted to any number of other locations. The numerical profile produced by computer 2 comprises a series of instructions that are used to control milling machine 3. When a piece of precious metal, or other material, is properly positioned in milling machine 3 the numerical profile of the image to be milled is sent from computer 2 to computer controlled milling machine 3. The numerical profile instructions cause the multi-dimensional image of the object, or person scanned, to be milled into the precious metal, or other substance, secured within milling machine 3.

The main components have been shown in FIG. 1 as three separate modules that are electrically connected to each other. However in alternative physical embodiments, the system may have two or more of the separate modules combined into an integrated unit. In all embodiments, the system provides a user interface, such as a keyboard and display unit within computer 2, for input by the operator/user.

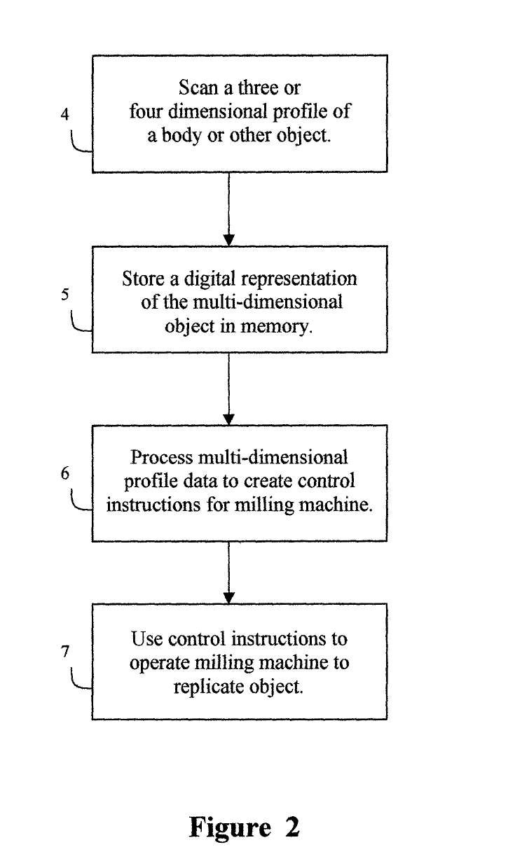

Referring to FIG. 2, a flow chart of the major steps in the present method of making jewelry is shown. To begin the method, in step 4, a person or object is scanned via one of the above mentioned scanning systems. The resulting data profile may easily contain hundreds of thousands of data points, which are the digital representation of the multi-dimensional object. In step 5, the captured digital profile is stored in a memory of a computer. In step 6, the captured data is processed by processing circuitry within the computer to create instructions, or numerical file, for a milling machine. Image conversion software within the computer controls the processing of the data and also allows for manipulation of the scanned images. The conversion software allows the user to control the size, distortion, and duplication of the object, or objects. Such manipulation of the numerical file allows for increased customization of the finished piece of jewelry.

For exemplary purposes only, an apple could be scanned to produce a four dimensional numerical code that contains data representing the apple's top, bottom, and four rounded sides. In the preferred embodiment computer 2 includes a monitor and the apple's image is viewed on computer 2 just as a person could view a real apple in the produce section of a grocery store before choosing to buy it. Further, the software of computer 2 allows duplication of the apple so for example, the user could place three apples set one upon another. The present conversion software produces new numerical codes based on location, position, size, and distortion of the apples with a set of numerical instructions. An exemplary instruction set, known as G-code, could be used to provide the instructions that control the operation of the milling machine in performing specific cutting functions.

If the image scanned were a boy named Benjamin for example, three images the front and both left and right profiles could be placed side by side and would be an option among the milling choices available to a customer. These instructions will allow the milling machine to perform very precise cutting functions in three, four, or five axis cutting planes. A three axis milling machine can produce raised rounded surfaces such as those of ears, noses, cheeks, and even hair. A three axis milling machine is also capable of producing a side profile of a boy on a flat surface. A four axis milling machine can produce a partial bust of a scanned boy's head. A partial bust being defined as the boy's face, ears, and top of the head can be seen. Five axis milling machines which can produce the full bust of the boy, suitable for mounting on a short column, are now commercially available.

During the milling process, the three dimensional or four dimensional product is cut out by the computer controlled devices of a three, four, or five axis milling machine. In any one of these milling machines the letters of the boy's name could also be milled so as to appear to rise up out of the surface of the substrate. Each letter of the boy's signature is machined higher than the background material, such as gold, yet each letter is contoured at different levels in accordance with sensitivity measurements recorded during the signature process. Coloring agents can be added to the piece of finished jewelry so as to enhance the look. Enamels and colored epoxies are two samples. Oxidation on sterling silver would be another.

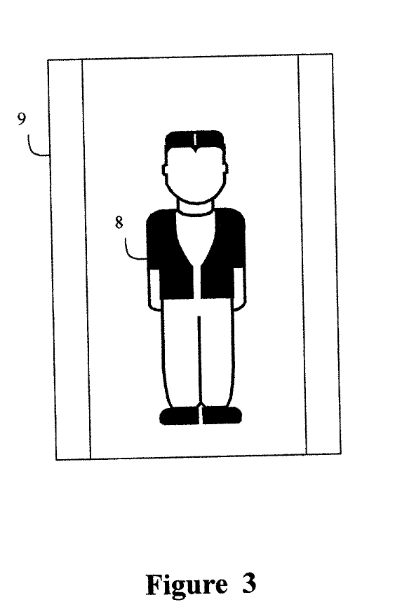

FIG. 3, graphically portrays one of our first subjects 8, a boy named Benjamin, standing in a scanning booth 9 so that his 3-D or 4-D image can be capture via one of the above mentioned scanning systems. In the preferred embodiment, a scanning booth is provided with one or more complementary cameras, or other sensing devices, that receive input regarding the subject's multi-dimensional image. While standing in booth 9, a digital representation of the subject is created. The subject's, Benjamin's, image is obtained using one of the above described full body scanning methods. More specifically a three-dimensional digital rendering of Benjamin is electronically captured. This captured “profile” of the subject 8 is then processed within computer 2 and a set of instructions for milling machine 3 is produced in accordance with operator input such as the material to be milled and the dimensions of the subject 8 to be reproduced.

Pieces of jewelry produced from this “electronic file” method of personalizing precious materials will be highly valued by members of Benjamin's family, as well as others. In an exemplary piece of jewelry, an image of Benjamin was incorporated into a pendant along with his birthstone and a reproduction of Benjamin's signature. In the present system the three dimensional image captured could also be from a device wherein the subject electronically signs a piece of paper on top of an electronically sensitive pad. The pad detects differences of pressure and assigns via signature software a three-dimensional sensitivity profile whereby a digital signature can be created and stored in the memory of a computer. The digital signature program when executed on the milling machine and milled on a material, such as gold for example, can produce a signature that is raised up from the gold in three-dimensions. The signature can also be altered using digital manipulation and shown turned sideways and milled in such a way as to produce a contoured signature.

The present system uses a numerical profile of the object to create an item of jewelry that is highly prized by the wearer either by the fact of sentimentality or by exactness and accuracy of the replication of the object or person(s). It is understandable that any two-, three-, or four-dimensional “scanning” method that reproduces a like-ness of a loved one on a precious material would be valuable in more than one way.

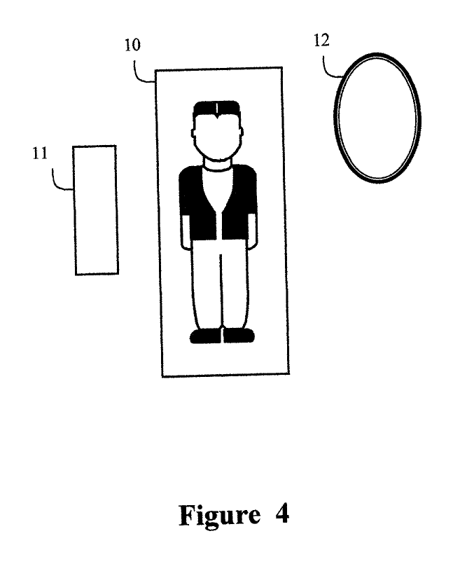

In FIG. 4, any portion of the digital profile 10 of Benjamin is available for milling into a given material, such as gold or ceramics. The full image 10 could be replicated in gold bar 11, for example, or the head portion alone of Benjamin could be duplicated on ivory medallion 12. Of course any 3 or 4-D portion of Benjamin 10 is available for 3 or 4-D duplication and manipulation by the processing circuitry of computer 2. It should be understood that the system is capable of completely reproducing a full replica in whatever subject was scanned in any material being cut, or milled. The present method works well in gold and silver, but is not limited to these two precious metals, as wood, glass and ceramics are also other appropriate materials. Another application of this would be to mill into an aluminum block thereby capturing the item as a cast. In yet another application, a glass rod is the material to be milled and a diamond coated drill bit is loaded into the very precise milling machine and a “bust” of Benjamin is downloaded into the milling machine with appropriate instructions. Now the finished product is a full bust of Benjamin in glass with exacting features such as nose, eyes, ears, etc. Again any cavities or flat surfaces created by the milling machine can be colored with epoxies, resins, enamels, or decorated further to give color contrast. Partial and segregated machining can also takes place. For example, a miniature full body of a boy can be cut out after being segregated. By the nature of the new capturing of exact facial and body measurements, there can now be the production of “personal” charms and pieces of jewelry.

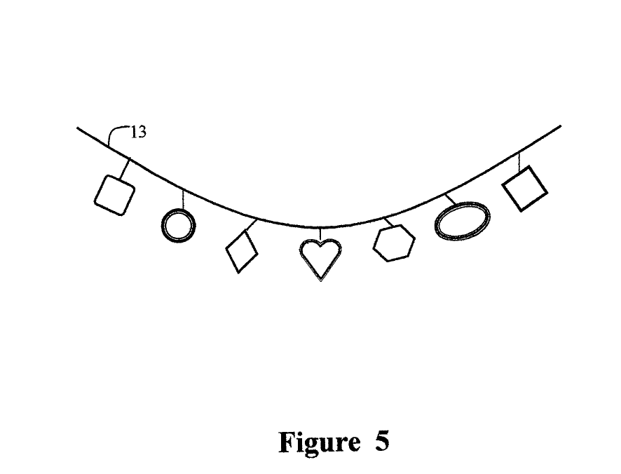

FIG. 5 shows necklace 13 with different shaped three-dimensional charms each having a different three-dimensional profile milled there into. An exemplary personalized necklace has an image of different dogs, all owned by the same owner, milled into each of the charms.

Another piece of jewelry that could be created using the present method is a silver half dome bell pendant into which is milled the faces of four children with two side profiles, a one and three quarter profile and a full front view. The present method allows the use of the fine features of a face now digitally captured to become an embellishment on any piece of jewelry. The milling process may be followed by a polishing and enameling process to make the piece of jewelry ready for retail.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A method of making personalized jewelry comprising the steps of:
scanning an object, or person, so that a full three-dimensional or four-dimensional digital profile of the object or person is created;
processing the digital profile to create a three-dimensional or four-dimensional numerical profile, wherein the numerical profile comprises instructions for a milling machine;
manipulating, sizing, multiplying, and/or distorting the digital profile via a user interface, and;
milling an entire image, or a portion of an image, of the object or person into a ring, broach, pendant, earring, charm, or other material that will ultimately be worn as a piece of jewelry.

2. The method of claim 1 wherein, the step of manipulating further comprises:
adding a digital background to the scanned object or person.

3. The method of claim 1 wherein, the step of processing further includes:
creating a numerical profile that allows the milling machine to completely replicate, in a reduced or miniaturized size, the scanned object or person.

4. The method of claim 1, further comprising the steps of:
soldering, stamping, polishing or using other finishing techniques on the piece of jewelry.

5. The method of claim 1, further comprising the steps of:
assembling, coloring, enameling or otherwise embellishing the piece of jewelry, with precious and semi-precious stones, for example.

6. The method of claim 1 wherein, the step of scanning further comprises
scanning a handwriting, or signature, that is received via a pressure sensitive writing pad to create the digital profile.

7. A machine for making a personalized piece of jewelry comprising:
a light based multi-dimensional digital scanning system, that captures a three or four dimensional digital image of a scanned object or person;
a computer, with a display unit and a keyboard, that receives the captured digital image from the scanning system and stores the scanned object or person's image data in a memory within the computer;
processing circuitry and software within the computer that processes the image data, allows for user input and manipulation of the image, and produces numeric data, wherein the numeric data comprises instructions that can be executed on a computer controlled milling machine;
a computer controlled milling machine that receives and executes instructions received from the computer that cause the milling machine to replicate a multi-dimensional image of the scanned object or person, or a portion of the scanned object or person, on a material held by the milling machine.

8. The machine of claim 7 wherein, the computer controlled milling machine is a three, four or five axis milling machine.

9. The machine of claim 7 wherein, the computer controlled milling machine is capable of full replication of the scanned object or person in a reduced or miniaturized size.

10. The machine of claim 7 wherein, the objects to be duplicated are a flower, a dog, an apple, or a shoe.

11. An article of manufacture comprising a precious or semi-precious, base metal, glass, wood, plastic, or other base material or combination thereof that has had an image of a scanned object or person milled into at least of portion of the base material to replicate at least a portion of the image to produce a piece of jewelry.

12. The article of claim 11 wherein, coloring agents such as epoxies, enamels, resins, oxidation applications are used on the piece of jewelry.

13. The article of claim 11 wherein, the scanned image is flowers, a dog, an apple or a shoe.

14. The article of claim 11 wherein, the scanned object or person is segmented and separate segments of the object or person are milled separately and then assembled to produce a finished piece of jewelry.
